(19) United States
(12) Patent Application Publication
(10) Pub. No.: US 2025/0118920 A1
(43) Pub. Date: Apr. 10, 2025

(54) FEMALE TERMINAL AND TERMINAL UNIT

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Takato MIZUNO, Mie (JP); Yusuke YAMADA, Mie (JP); Tomohiro HAYASHI, Mie (JP); Katsuhiko AIZAWA, Mie (JP)

(21) Appl. No.: 18/908,024

(22) Filed: Oct. 7, 2024

(30) Foreign Application Priority Data
Oct. 10, 2023 (JP) 2023-175266

(51) Int. Cl. H01R 13/11; H01R 13/631

(52) U.S. Cl. CPC H01R 13/111; H01R 13/631; H01R 2201/26

(57) ABSTRACT

A female terminal includes a tubular portion provided in a first peripheral wall, a tubular portion provided in a peripheral wall to face the tubular portion, and a tubular connecting portion constituted by the first and second tubular portions. The tubular connecting portion is a part, into which a columnar connecting portion of a male terminal is inserted along a third direction and to which the columnar connecting portion is electrically connected. Both the first and second tubular portions include a first guide-in portion provided in a first end part in an axial direction of the tubular connecting portion for guiding the columnar connecting portion into the tubular connecting portion. An inner peripheral surface of the first guide-in portion is formed into a first inclined surface inclined radially outwardly of the tubular connecting portion toward a first opening end of the tubular connecting portion in the first end part.

### CROSS-REFERENCE TO RELATED APPLICATIONS

This application is based on and claims priority from Japanese Patent Application No. 2023-175266, filed on Oct. 10, 2023, with the Japan Patent Office, the disclosure of which is incorporated herein in its entirety by reference.

### TECHNICAL FIELD

The present disclosure relates to a female terminal and a terminal unit.

### BACKGROUND

Conventionally, a connector provided with a female terminal and a housing for holding the female terminal is known as a connector to be installed in a vehicle. A columnar connecting portion of a male terminal is inserted into and electrically connected to a tubular connecting portion of the female terminal. The female terminal of this type stably ensures a contact pressure with the columnar connecting portion of the male terminal, utilizing a biasing force by a biasing member such as a coil spring (see, for example, Japanese Patent Laid-open Publication No. 2021-028903).

### SUMMARY

In the above connector, it is desired to easily align a center axis of the tubular connecting portion and that of the columnar connecting portion in inserting the columnar connecting portion into the tubular connecting portion.

The present disclosure aims to provide a female terminal and a terminal unit enabling easy alignment of a center axis of a tubular connecting portion and that of a columnar connecting portion.

The present disclosure is directed to a female terminal with a first peripheral wall extending along a first direction, a second peripheral wall extending along the first direction, the second peripheral wall facing the first peripheral wall in a second direction orthogonal to the first direction, a first tubular portion provided in the first peripheral wall, a second tubular portion provided in the second peripheral wall to face the first tubular portion, and a tubular connecting portion constituted by the first and second tubular portions, an axial direction of the tubular connecting portion extending along a third direction intersecting both the first and second directions, a columnar connecting portion of a male terminal being inserted into the tubular connecting portion along the third direction, the columnar connecting portion being electrically connected to the tubular connecting portion, both the first and second tubular portions including a first guide-in portion provided in a first end part in the axial direction for guiding the columnar connecting portion into the tubular connecting portion, and an inner peripheral surface of the first guide-in portion being formed into a first inclined surface inclined radially outwardly of the tubular connecting portion toward a first opening end of the tubular connecting portion in the first end part.

According to a female terminal and a terminal unit of the present disclosure, it is possible to achieve an effect of enabling easy alignment of a center axis of a tubular connecting portion and that of a columnar connecting portion.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view showing a wiring harness of one embodiment.

FIG. 2 is an exploded perspective view showing the wiring harness of the embodiment.

FIG. 3 is an exploded perspective view showing the wiring harness of the embodiment.

FIG. 4 is a perspective view showing a terminal unit of the embodiment.

FIG. 5 is a plan view showing the terminal unit of the embodiment.

FIG. 6 is a plan view showing the terminal unit of the embodiment.

FIG. 7 is a section (section along 7-7 in FIGS. 5 and 6) showing the terminal unit of the embodiment.

FIG. 8 is a section (section along 8-8 in FIGS. 5 and 6) showing the terminal unit of the embodiment.

FIG. 9 is a plan view showing the terminal unit of the embodiment.

FIG. 10 is a perspective view in section showing a female terminal of the embodiment.

FIG. 11 is a section showing the terminal unit of the embodiment.

FIG. 12 is a section (section along 12-12 in FIGS. 5 and 6) showing the female terminal of the embodiment.

FIG. 13 is a section (section along 13-13 in FIG. 12) showing the female terminal of the embodiment.

FIG. 14 is a perspective view in section showing the female terminal of the embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### DESCRIPTION OF EMBODIMENTS OF PRESENT DISCLOSURE

Embodiments of the present disclosure are first listed and described.

[1] The female terminal of the present disclosure is provided with a first peripheral wall extending along a first direction, a second peripheral wall extending along the first direction, the second peripheral wall facing the first peripheral wall in a second direction orthogonal to the first direction, a first tubular portion provided in the first peripheral wall, a second tubular portion provided in the second peripheral wall to face the first tubular portion, and a tubular connecting portion constituted by the first and second tubular portions, an axial direction of the tubular connecting portion extending along a third direction intersecting both the first and second directions, a columnar connecting portion of a male terminal being inserted into the tubular connecting portion along the third direction, the columnar connecting portion being electrically connected to the tubular connecting portion, both the first and second tubular portions including a first guide-in portion provided in a first end part in the axial direction for guiding the columnar connecting portion into the tubular connecting portion, and an inner peripheral surface of the first guide-in portion being formed into a first inclined surface inclined radially outwardly of the tubular connecting portion toward a first opening end of the tubular connecting portion in the first end part.

According to this configuration, the inner peripheral surface of the first guide-in portion provided in the first end part in the axial direction of the tubular connecting portion is formed into the first inclined surface inclined radially outwardly toward the first opening end in the first end part. Thus, when the columnar connecting portion of the male terminal is inserted into the tubular connecting portion, a tip part of the columnar connecting portion is guided into the tubular connecting portion along the first inclined surface of the first guide-in portion. In this way, even if a center axis of the columnar connecting portion deviates from a center axis of the tubular connecting portion, the center axis of the columnar connecting portion can be aligned with the center axis of the tubular connecting portion by moving the tip part of the columnar connecting portion along the first inclined surface. As a result, by providing the first guide-in portion, the center axis of the tubular connecting portion and that of the columnar connecting portion can be easily aligned in inserting the columnar connecting portion into the tubular connecting portion.

[2] In [1] described above, the first guide-in portion may be formed to project further outward than an outer peripheral surface of the tubular connecting portion excluding the first guide-in portion, and a thickness of the first guide-in portion may be equal to that of the tubular connecting portion excluding the first guide-in portion.

According to this configuration, the first guide-in portion is formed to have the same thickness as the other part of the tubular connecting portion. Thus, a conductor cross-sectional area of the tubular connecting portion can be increased as compared to the case where the first inclined surface is formed by making the guide-in portion thinner toward the first opening end. In this way, a heat capacity of the female terminal can be increased and a conductor resistance of the female terminal can be reduced. As a result, a temperature increase of the female terminal during energization can be suitably suppressed.

[3] In [1] or [2] described above, both the first and second tubular portions may include a second guide-in portion provided in a second end part in the axial direction for guiding the columnar connecting portion into the tubular connecting portion, and an inner peripheral surface of the second guide-in portion may be formed into a second inclined surface inclined radially outwardly of the tubular connecting portion toward a second opening end of the tubular connecting portion in the second end part.

According to this configuration, the first and second guide-in portions are respectively provided in the both end parts in the axial direction of the tubular connecting portion, i.e. in the first and second end parts. Thus, regardless of in which of the both end parts of the tubular connecting portion an insertion opening for the columnar connecting portion into the tubular connecting portion is set, the columnar connecting portion can be inserted into the tubular connecting portion while the center axis of the tubular connecting portion and that of the columnar connecting portion are aligned. Therefore, limitations in an insertion direction of the columnar connecting portion with respect to the axial direction of the tubular connecting portion can be eliminated.

[4] In any one of [1] to [3] described above, the first tubular portion may include a plurality of divided tubular portions divided in the axial direction, and each of the plurality of divided tubular portions may have a first inner surface facing the second tubular portion and a protruding portion arcuately projecting radially inwardly of the tubular connecting portion from the first inner surface in cross-section.

According to this configuration, when the columnar connecting portion of the male terminal is press-fit into the tubular connecting portion, the protruding portions provided on the respective first inner surfaces of the plurality of divided tubular portions are pressed into contact with the outer peripheral surface of the columnar connecting portion. Thus, in the tubular connecting portion, the plurality of protruding portions are brought into contact with the outer peripheral surface of the columnar connecting portion at a plurality of positions separated in the axial direction. In this way, for example, even if a swinging motion is transferred to the male terminal, a displacement of the male terminal due to that swinging motion can be suitably hindered by the contact of the plurality of protruding portions with the columnar connecting portion. That is, a displacement of the columnar connecting portion inside the tubular connecting portion can be suppressed by a contact pressure by the plurality of protruding portions as compared to the case where only one protruding portion is provided on the inner surface of the tubular portion.

[5] In [4] described above, the plurality of divided tubular portions may be two divided tubular portions, the first tubular portion may include a slit dividing the two divided tubular portions, and the slit may be provided at a center position of the tubular connecting portion in the axial direction.

According to this configuration, the slit dividing the two divided tube portions is provided in a center in the axial direction of the tubular connecting portion. At this time, when the columnar connecting portion of the male terminal inserted into the tubular connecting portion is displaced, the columnar connecting portion rotates about the center in the axial direction of the tubular connecting portion as a rotation center. If a contact part of the protruding portion and the columnar connecting portion is provided at such a rotation center, a contact pressure by the protruding portion cannot be applied as a force for suppressing a displacement of the columnar connecting portion. In contrast, in the above configuration, the protruding portions are provided at positions different from the rotation center provided in the center in the axial direction of the tubular connecting portion. Thus, the protruding portions and the columnar connecting portion can be brought into contact at the positions different from the rotation center in the displacement of the columnar connecting portion. In this way, a contact pressure by the protruding portions can be suitably applied as a force for suppressing the displacement of the columnar connecting portion. As a result, the displacement of the columnar connecting portion inside the tubular connecting portion can be suitably suppressed by the contact pressure by the plurality of protruding portions.

[6] In [5] described above, each of the two divided tubular portions may include a guiding portion provided in a third end part directly communicating with the slit, an inner peripheral surface of the guiding portion may be formed into a third inclined surface inclined radially outwardly of the tubular connecting portion toward the slit, and the guiding portion may be formed to make the divided tubular portion thinner toward the slit.

According to this configuration, the inner peripheral surface of the guiding portion provided in the third end part of the divided tube portion is formed into the third inclined surface inclined radially outwardly toward the slit. Thus, when the tip part of the columnar connecting portion is inserted into the divided tube portion through the slit, the tip part of the columnar connecting portion is guided into the divided tube portion along the third inclined surface of the guiding portion. In this way, the columnar connecting portion can be smoothly guided into the divided tube portion.

[7] In [6] described above, the first inclined surface may extend along a first oblique direction inclined at a first angle of inclination with respect to the center axis of the tubular connecting portion, the third inclined surface may extend along a second oblique direction inclined at a second angle of inclination with respect to the center axis, and a dimension of the first inclined surface along the first oblique direction may be larger than a dimension of the third inclined surface along the second oblique direction.

According to this configuration, the first inclined surface can be formed to be long along the first oblique direction. In this way, a distance from the first opening end to a contact point part of the tubular connecting portion can be made longer. Thus, when the columnar connecting portion is inserted into the tubular connecting portion, a moving distance of the columnar connecting portion can be made longer while the center axis of the tubular connecting portion and that of the columnar connecting portion are aligned. Therefore, the alignment accuracy of the center axis of the tubular connecting portion and that of the columnar connecting portion can be improved.

[8] In [7] described above, the first angle of inclination may be smaller than the second angle of inclination.

According to this configuration, the first inclined surface is formed into an inclined surface inclined more gently than the third inclined surface. Thus, when the columnar connecting portion is inserted into the tubular connecting portion, a pressure generated between the tip part of the columnar connecting portion and the first inclined surface can be reduced. In this way, the amount of wear of the tubular connecting portion during the insertion of the columnar connecting portion can be reduced.

[9] In any one of [4] to [8] described above, the second tubular portion may have a second inner surface facing the first inner surface, the female terminal may further include a wound pressing portion for limiting a separation distance between the first and second inner surfaces, the wound pressing portion may be integrally formed to the second peripheral wall, and the wound pressing portion may extend from the second peripheral wall, be folded while embracing an end edge of the first peripheral wall inside and be in contact with an outer surface of the first peripheral wall.

According to this configuration, when the columnar connecting portion of the male terminal is press-fit into the tubular connecting portion, an increase in the separation distance between the first inner surface constituting the tubular connecting portion and the second inner surface constituting the tubular connecting portion is limited by the wound pressing portion. By this limitation by the wound pressing portion, the protruding portions can be suitably brought into contact with the outer peripheral surface of the columnar connecting portion. As a result, a contact state of the tubular connecting portion and the columnar connecting portion can be stably maintained. Further, the wound pressing portion is integrally formed to the second peripheral wall. Thus, the contact state of the tubular connecting portion and the columnar connecting portion can be maintained by a simple structure as compared to the case of using a separate component such as a coil spring. That is, the structure of the female terminal can be simplified as compared to the case of using a separate component such as a coil spring.

[10]A terminal unit of the present disclosure is provided with the female terminal of any one of [1] to [9] described above, and the male terminal including the columnar connecting portion to be inserted into the tubular connecting portion.

According to this configuration, effects similar to those of the female terminal of [1] described above can be obtained.

[11] In [10] described above, the columnar connecting portion may include a tip part formed into a tapered shape, and an outer peripheral surface of the tip part may extend in parallel to the first inclined surface.

According to this configuration, when the columnar connecting portion is inserted into the tubular connecting portion, the outer peripheral surface of the tip part of the columnar connecting portion and the first inclined surface extending in parallel to that outer peripheral surface are brought into contact with each other. Thus, as compared to the case where a slope and a perpendicular surface are brought into contact with each other, a contact area of the outer peripheral surface of the tip part and the first inclined surface during the insertion of the columnar connecting portion can be increased. In this way, a surface pressure applied to the first inclined surface from the tip part of the columnar connecting portion can be suitably reduced. Therefore, the amount of wear of the columnar connecting portion and the tubular connecting portion during the insertion of the columnar connecting portion can be suitably reduced.

### DETAILS OF EMBODIMENT OF PRESENT DISCLOSURE

Specific examples of a female terminal and a terminal unit of the present disclosure are described below with reference to the drawings. For the convenience of description, some components may be shown in an exaggerated or simplified manner in each drawing. Further, a dimension ratio of each part may be different in each drawing. “Parallel” and “orthogonal” in this specification mean not only strictly parallel and orthogonal, but also substantially parallel and orthogonal within a range in which functions and effects in this embodiment are achieved. In this specification, a term “equal” means also a case where objects to be compared are slightly different due to dimensional tolerances and the like, besides meaning exactly equal. A term “tubular” used in the description of this specification indicates not only a shape formed by a peripheral wall continuous over an entire periphery in a circumferential direction, but also a shape formed by combining a plurality of components and a shape having a cut or the like in a circumferential part such as a C shape and a U shape. Note that the “tubular” shapes include circular shapes, elliptical shapes and polygonal shapes with angular or rounded corners, but there is no limitation to these. Further, “facing each other” in this specification indicates that surfaces or members are at positions in front of each other, and means not only a case where the surfaces or members are at positions perfectly in front of each other, but also a case where the surfaces or members are at positions partially in front of each other. Further, “facing each other” in this specification means both a case where another member different from two parts is interposed between the two parts and a case where nothing is interposed between the two parts. Further, terms such as “first”, “second” and “third” in this specification are merely used to distinguish objects and do not rank the objects. Note that the present invention is not limited to these illustrations, but is represented by claims and intended to include all changes in the scope of claims and in the meaning and scope of equivalents.

### (Overall Configuration of Wiring Harness W1)

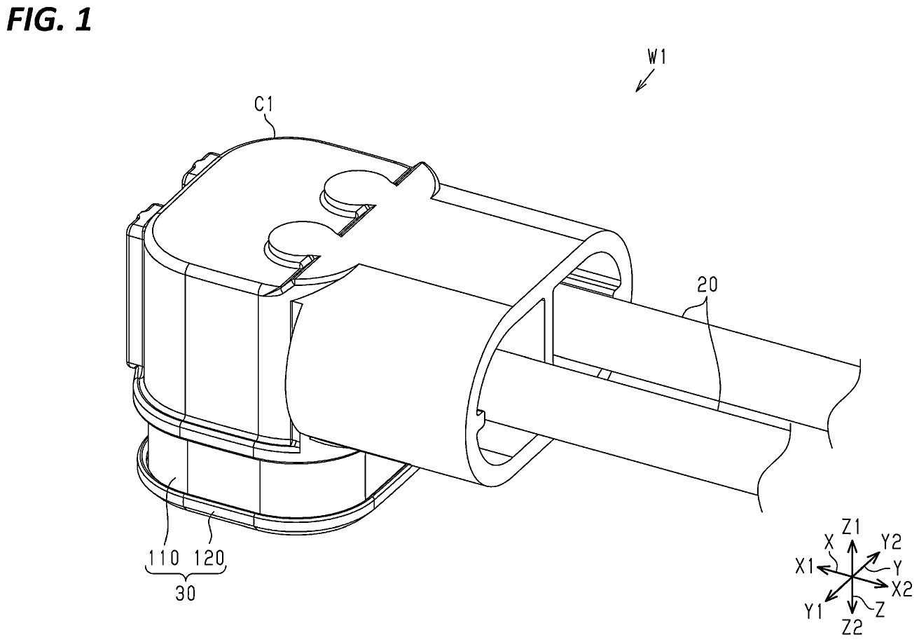

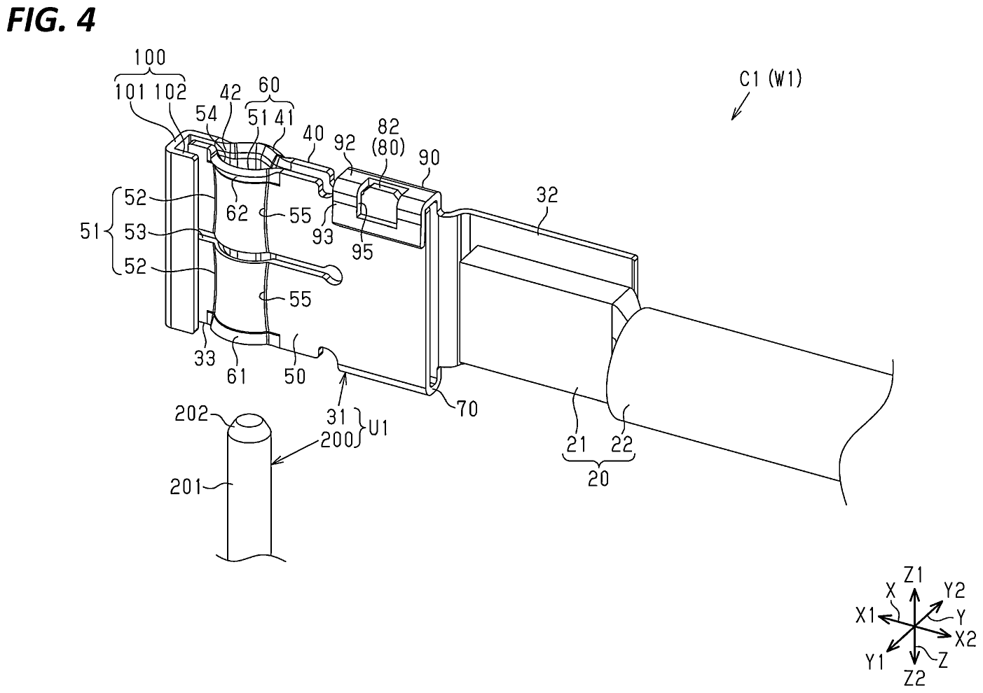

As shown in FIG. 1, a wiring harness W1 is provided with one or more (two in this embodiment) wires 20 and a connector C1 mounted on end parts of the wires 20. The wiring harness W1 is, for example, for electrically connecting electrical devices for vehicle to each other. An inverter and a wheel drive motor can be, for example, cited as the electrical devices for vehicle. Although not shown in detail, the connector C1 is electrically connected to a mating connector provided on the electrical device. The mating connector is, for example, provided with one or more (two in this embodiment) male terminals 200 (see FIG. 4) as mating terminals and a mating housing for holding the two male terminals 200. Note that each direction in each figure does not necessarily indicate the postures of the connector C1 and the wiring harness W1 during use.

### (Overall Configuration of Connector C1)

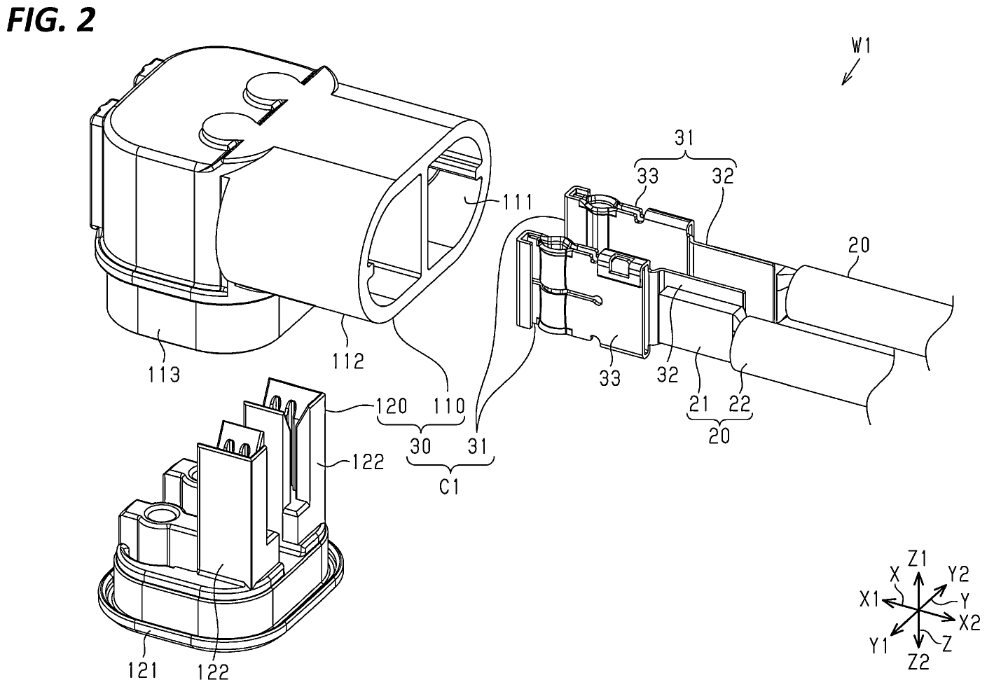

As shown in FIG. 2, the connector C1 is provided with a housing 30 and a plurality of female terminals 31 respectively connected to the end parts of the plurality of wires 20. The housing 30 holds the plurality of wires 20 and the plurality of female terminals 31. The housing 30 includes a housing body 110 for accommodating the plurality of female terminals 31 inside and a retainer 120 to be mounted into the housing body 110. Note that an X axis, a Y axis and a Z axis orthogonal to each other are shown in each figure. Each figure shows a first direction X1, which is one X-axis direction along the X axis, and a first opposite direction X2, which is a direction opposite to the first direction X1. Each figure shows a second direction Y1, which is one Y-axis direction along the Y axis, and a second opposite direction Y2, which is a direction opposite to the second direction Y1. Each figure shows a third direction Z1, which is one Z-axis direction along the Z axis, and a third opposite direction Z2, which is a direction opposite to the third direction Z1. Each direction described above is a direction in a state where the connector C1 is assembled with the end parts of the wires 20 unless otherwise particularly stated.

The female terminals 31 and the wires 20 are inserted into the housing body 110 along the first direction X1. The retainer 120 is mounted into the housing body 110 along the third direction Z1. The mating connector is connected to the connector C1, for example, along the third direction Z1. For example, the male terminals 200 (see FIG. 4) of the mating connector are inserted into the housing body 110 along the third direction Z1.

### (Configuration of Wire 20)

Each wire 20 includes an electrically conductive core wire 21 and an insulation coating 22 surrounding the outer periphery of the core wire 21 and having an insulating property. A stranded wire formed by twisting a plurality of metal strands or a single core wire made of a single conductor can be, for example, used as the core wire 21. The insulation coating 22 covers, for example, the outer peripheral surface of the core wire 21 over an entire periphery in a circumferential direction.

An end part in the first direction X1 of the core wire 21 is exposed from the insulation coating 22. The female terminal 31 is connected to the end part in the first direction X1 of the core wire 21 exposed form the insulation coating 22.

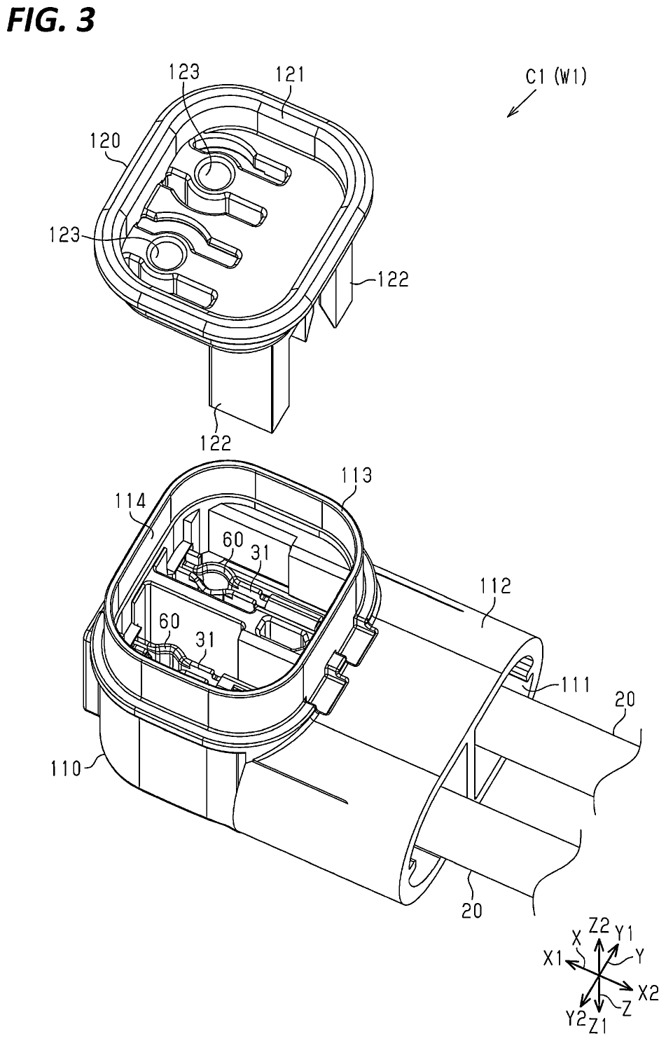

As shown in FIG. 3, an end part in the first direction X1 of the core wire 21 is accommodated inside the housing body 110. The wire 20 is drawn out in the first opposite direction X2 from an end part in the first opposite direction X2 of the housing body 110.

### (Configuration of Female Terminal 31)

As shown in FIG. 2, two female terminals 31 are respectively electrically connected to the two wires 20. The two female terminals 31 are, for example, provided side by side along the Y-axis direction. The two female terminals 31 have, for example, the same structure. Here, the female terminal 31 provided on the side in the second direction Y1, out of the two female terminals 31, is focused and described.

Each female terminal 31 includes a wire connecting portion 32 to be connected to the end part of the wire 20 and a terminal connecting portion 33 extending in the first direction X1 from an end part in the first direction X1 of the wire connecting portion 32. Each female terminal 31 is, for example, a single component in which the wire connecting portion 32 and the terminal connecting portion 33 are continuously and integrally formed. Each female terminal 31 of this embodiment is formed by bending one metal plate material. Each female terminal 31 is, for example, made of metal. A copper-based or aluminum-based metal material can be, for example, used as a material of each female terminal 31.

The wire connecting portion 32 is connected to the end part of the core wire 21 exposed from the insulation coating 22. The wire connecting portion 32 is, for example, in the form of a flat plate. The wire connecting portion 32 extends, for example, like a strip along the X-axis direction. The wire connecting portion 32 is connected to the core wire 21, for example, by crimping or ultrasonic welding. In this way, the wire connecting portion 32 and the core wire 21 are electrically and mechanically connected.

As shown in FIG. 4, the terminal connecting portion 33 is a female terminal portion to be connected to the male terminal 200 of the mating connector. Here, the male terminal 200 includes a columnar connecting portion 201. The columnar connecting portion 201 of this embodiment is formed into a cylindrical shape. Note that a terminal unit U1 is constituted by the female terminal 31 and the male terminal 200.

The terminal connecting portion 33 includes a peripheral wall 40 having a tubular portion 41, a peripheral wall 50 having a tubular portion 51 facing the tubular portion 41 and a tubular connecting portion 60. The terminal connecting portion 33 includes, for example, a coupling portion 70, a projecting portion 80, a wound pressing portion 90 and a protecting portion 100. The peripheral walls 40, 50 are facing each other in the Y-axis direction.

### (Configurations of Peripheral Walls 40 and 50)

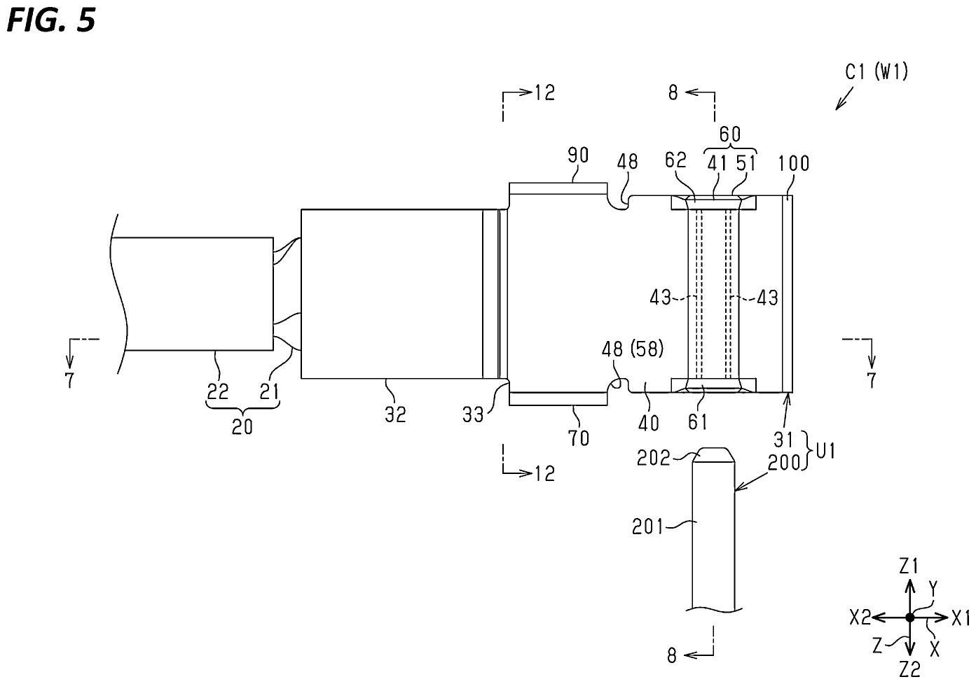

As shown in FIGS. 4 and 5, an end part in the first opposite direction X2 of the peripheral wall 40 is connected to the end part in the first direction X1 of the wire connecting portion 32. The peripheral wall 40 is in the form of a strip extending along the first direction X1. The peripheral wall 40 extends, for example, in the first direction X1 from the end part in the first direction X1 of the wire connecting portion 32. The peripheral wall 40 is, for example, in the form of a flat plate. As shown in FIG. 4, the peripheral wall 40 has an inner surface facing the peripheral wall 50 and an outer surface provided on a side opposite to the inner surface in the Y-axis direction.

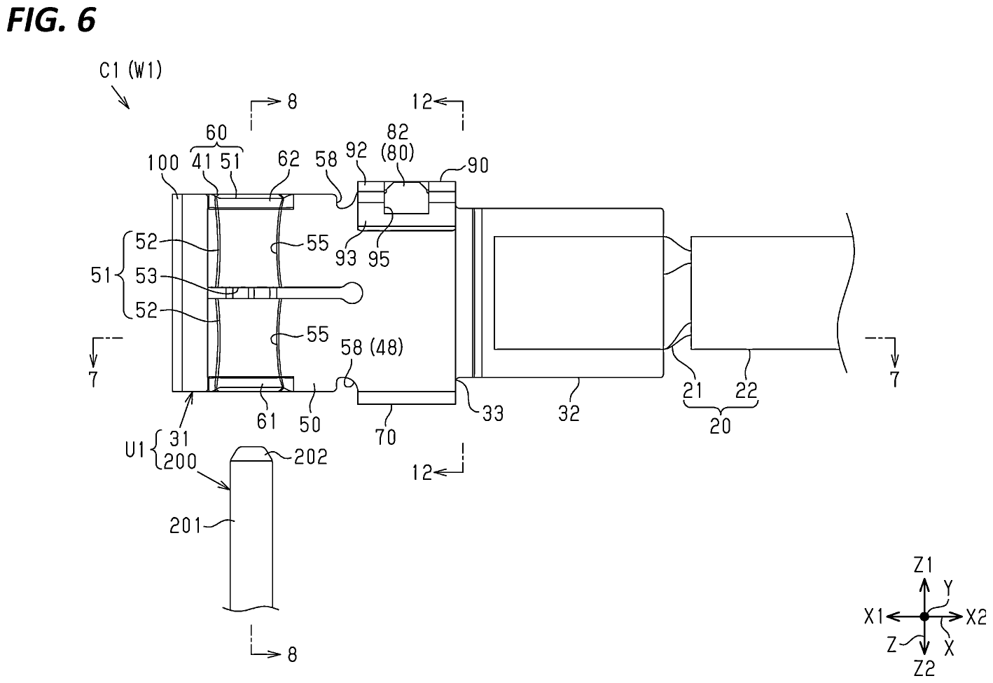

As shown in FIGS. 4 and 6, the peripheral wall 50 is in the form of a strip extending along the first direction X1. The peripheral wall 50 is, for example, in the form of a flat plate. As shown in FIG. 4, the peripheral wall 50 has an inner surface facing the inner surface of the peripheral wall 40 and an outer surface provided on a side opposite to the inner surface in the Y-axis direction. The inner surface of the peripheral wall 50 is separated from the inner surface of the peripheral wall 40 in the Y-axis direction. The peripheral wall 50 extends, for example, in parallel to the peripheral wall 40.

The tubular portion 41 is provided at an intermediate position in the X-axis direction of the peripheral wall 40. The tubular portion 41 is provided between the wound pressing portion 90 and the protecting portion 100 in the X-axis direction. The tubular portion 41 is formed into a half tube shape as a whole. As shown in FIG. 5, the tubular portion 41 extends over the entire length in the Z-axis direction of the peripheral wall 40 along the Z-axis direction.

As shown in FIG. 4, the tubular portion 51 is provided at an intermediate position in the X-axis direction of the peripheral wall 50. The tubular portion 51 is provided between the wound pressing portion 90 and the protecting portion 100 in the X-axis direction. The tubular portion 51 is formed into a half tube shape as a whole. The tubular portion 51 extends over the entire length in the Z-axis direction of the peripheral wall 50 along the Z-axis direction.

The tubular portions 41, 51 are curved in directions separating from each other. The tubular connecting portion 60 is constituted by the tubular portions 41, 51. The tubular connecting portion 60 is a part, into which the columnar connecting portion 201 of the male terminal 200 is inserted along the third direction Z1 and to which the columnar connecting portion 201 is electrically connected. An axial direction of the tubular connecting portion 60 extends along a direction intersecting an extension direction (herein, X-axis direction) of the peripheral walls 40, 50, along the Z-axis direction in this embodiment. The tubular connecting portion 60 is open on both ends in the Z-axis direction.

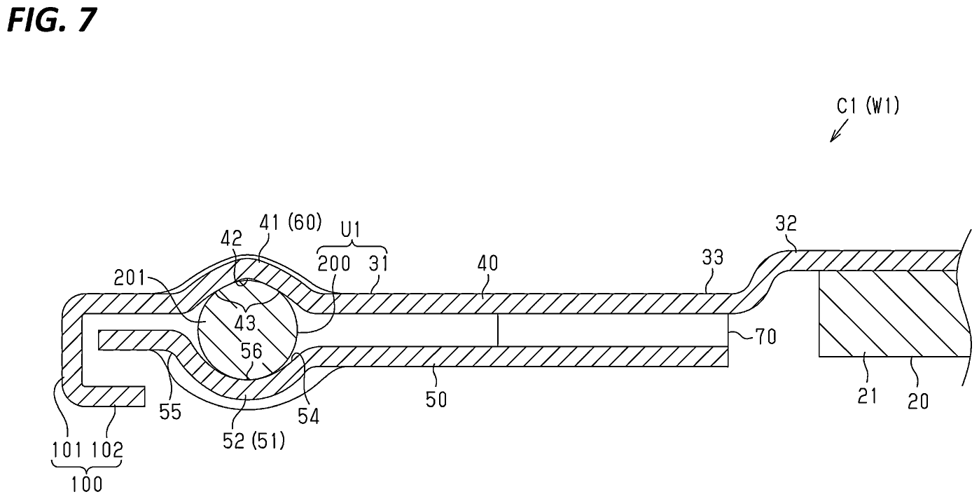

As shown in FIG. 7, the tubular connecting portion 60 is, for example, formed into a hollow cylindrical shape as a whole. The tubular connecting portion 60 has, for example, a maximum inner diameter smaller than a maximum outer diameter of the columnar connecting portion 201. That is, the tubular connecting portion 60 is so configured that the columnar connecting portion 201 is press-fit into the tubular connecting portion 60.

The tubular portion 41 has an inner surface 42 facing in the second direction Y1 and an outer surface provided on a side opposite to the inner surface 42. The outer surface of the tubular portion 41 is formed such that a cross-sectional shape of the tubular portion 41 cut by a plane parallel to the X-axis direction is an arcuately curved surface. The outer surface of the tubular portion 41 arcuately projects radially outwardly of the tubular connecting portion 60 in cross-section. Similarly, the inner surface 42 of the tubular portion 41 is formed to be arcuately recessed radially outwardly of the tubular connecting portion 60 in cross-section.

A plurality of (two in this embodiment) linear contact portions 43 projecting radially inwardly of the tubular connecting portion 60 from the inner surface 42 are provided on the inner surface 42 of the tubular portion 41. The two linear contact portions 43 are provided at positions spaced apart from each other in a circumferential direction of the tubular connecting portion 60. The two linear contact portions 43 are, for example, partially facing each other in the X-axis direction. As shown in FIG. 5, each linear contact portion 43 extends, for example, along the axial direction (here, Z-axis direction) of the tubular connecting portion 60.

As shown in FIG. 7, a curvature of the inner surface 42 including the two linear contact portions 43 is set to be smaller than that of the outer peripheral surface of the columnar connecting portion 201 of the male terminal 200. In this way, the two linear contact portions 43 can be suitably brought into contact with the outer peripheral surface of the columnar connecting portion 201. At this time, each linear contact portion 43 is held linearly in contact with the outer peripheral surface of the columnar connecting portion 201 along the axial direction of the tubular connecting portion 60. That is, each linear contact portion 43 is held in line contact with the outer peripheral surface of the columnar connecting portion 201.

As shown in FIG. 6, the tubular portion 51 includes a plurality of (two in this embodiment) divided tubular portions 52 divided in the axial direction of the tubular connecting portion 60 and a slit 53 dividing the two divided tubular portions 52. The two divided tubular portions 52 are provided apart from each other across the slit 53 in the axial direction of the tubular connecting portion 60. The two divided tubular portions 52 have, for example, the same structure. The two divided tubular portions 52 are formed to be plane-symmetrical with respect to a virtual plane including a center of the slit 53 in the Z-axis direction and extending in both the first direction X1 and the first opposite direction X2.

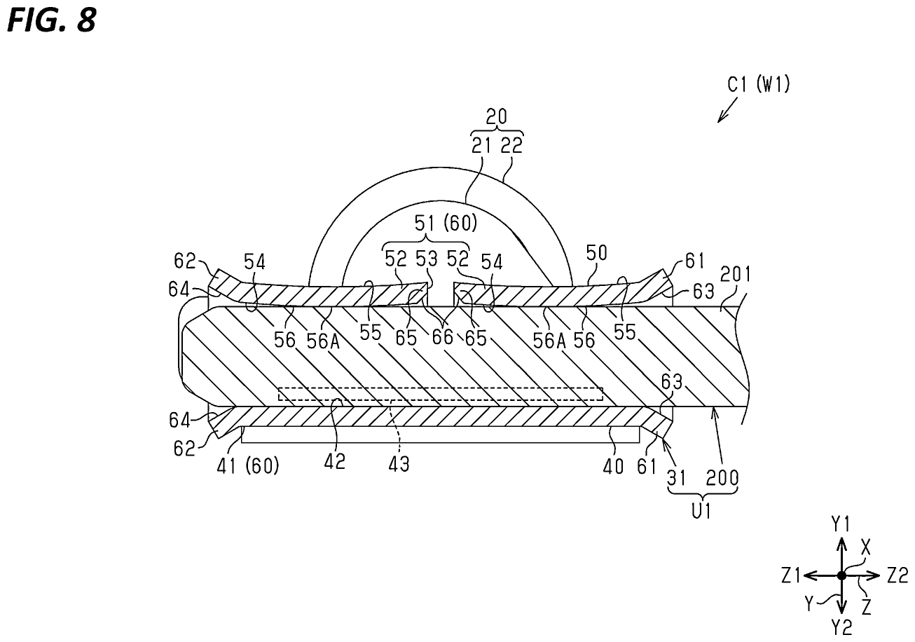

As shown in FIG. 8, each divided tubular portion 52 has an inner surface 54 facing in the second opposite direction Y2 and an outer surface provided on a side opposite to the inner surface 54. As shown in FIG. 7, the outer surface of each divided tubular portion 52 is formed such that a cross-sectional shape of the divided tubular portion 52 cut by a plane parallel to the X-axis direction is an arcuately curved surface. The outer surface of the divided tubular portion 52 arcuately projects radially outwardly of the tubular connecting portion 60 in cross-section. Similarly, the inner surface 54 of the divided tubular portion 52 is formed to be arcuately recessed radially outwardly of the tubular connecting portion 60 in cross-section.

As shown in FIG. 8, a recessed portion 55 recessed radially inwardly of the tubular connecting portion 60 from the outer surface of each divided tubular portion 52 is provided in this outer surface. As shown in FIG. 6, the recessed portion 55 is formed to have, for example, a rectangular plan view shape when viewed from the Y-axis direction. The recessed portion 55 is, for example, formed over the entire length of the divided tubular portion 52 in the Z-axis direction.

As shown in FIG. 8, the inner surface 54 of each divided tubular portion 52 is provided with a protruding portion 56 projecting radially inwardly of the tubular connecting portion 60 from the inner surface 54. The protruding portion 56 is, for example, provided on the inner surface 54 of the divided tubular portion 52 in a part where the recessed portion 55 is formed. The protruding portion 56 can be, for example, formed by embossing. The protruding portion 56 is formed into an embossed shape by pressing the outer surface of the divided tubular portion 52 by a die.

The protruding portion 56 is, for example, formed such that a cross-sectional shape of the protruding portion 56 cut by a plane parallel to the axial direction (here, Z-axis direction) of the tubular connecting portion 60 arcuately projects radially inwardly of the tubular connecting portion 60. The protruding portion 56 arcuately projects radially inwardly of the tubular connecting portion 60 from the inner surface 54 in cross-section. The protruding portion 56 extends along the circumferential direction of the tubular connecting portion 60. The protruding portion 56 extends along the axial direction of the tubular connecting portion 60. A projecting tip 56A of the protruding portion 56 is, for example, held in point contact with the outer peripheral surface of the columnar connecting portion 201 of the male terminal 200.

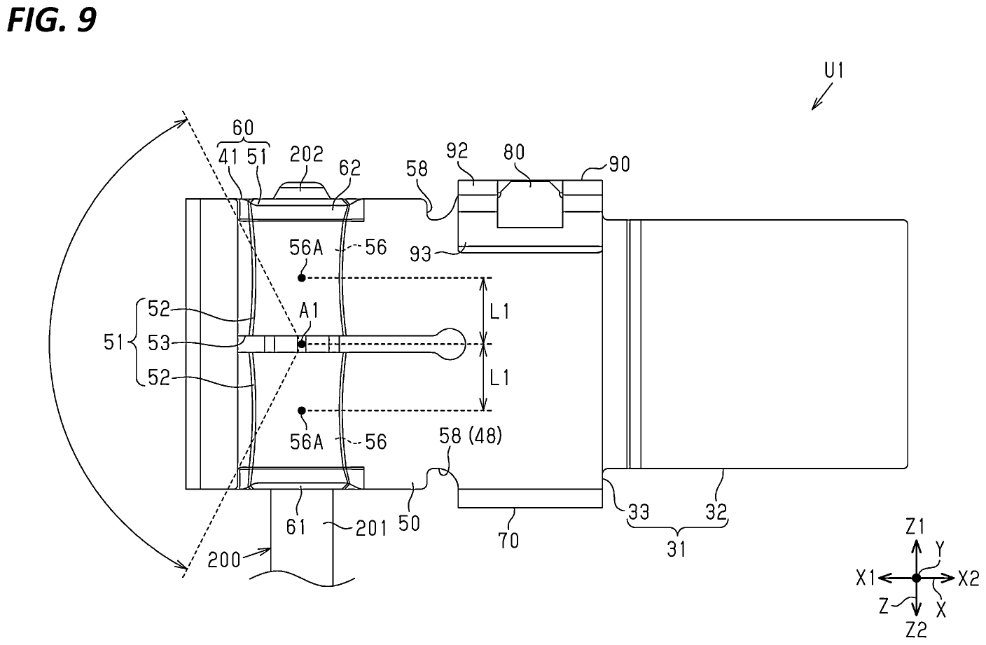

As shown in FIG. 9, each projecting tip 56A is provided in a center in the axial direction of the divided tubular portion 52. Each projecting tip 56A is provided at a position separated from a center A1 in the axial direction of the tubular connecting portion 60 by a first distance L1 in the axial direction of the tubular connecting portion 60. Each projecting tip 56A is provided in a center in the X-axis direction of the divided tubular portion 52.

The slit 53 is provided to penetrate through the tubular portion 51 in the Y-axis direction. The slit 53 is provided at a center position of the tubular connecting portion 60 in the axial direction of the tubular connecting portion 60.

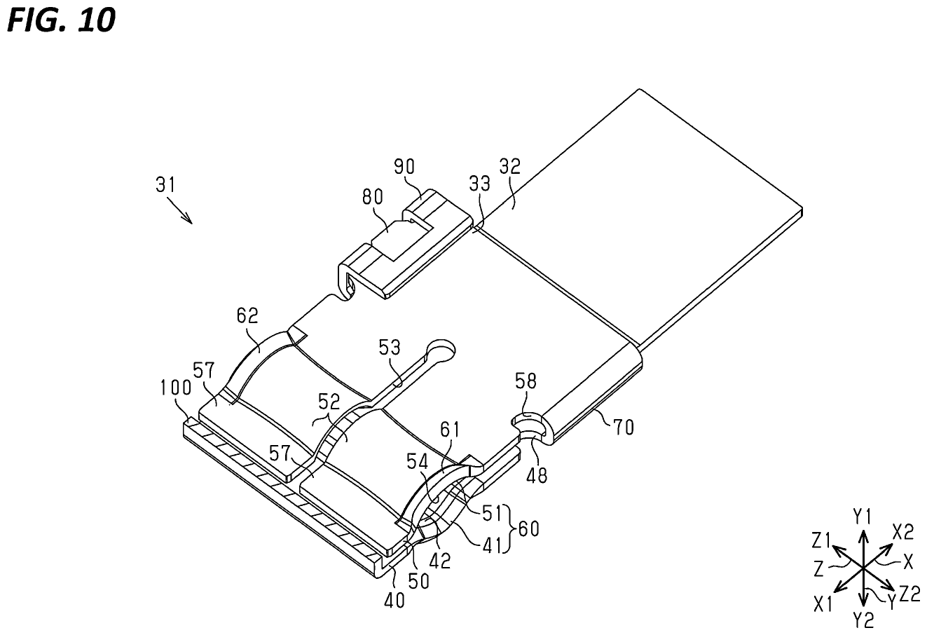

As shown in FIG. 10, the slit 53 extends over an entire length along a circumferential direction of the tubular portion 51. The slit 53 extends, for example, to a position further in the first opposite direction X2 than the divided tubular portions 52 along the first opposite direction X2 from an end surface in the first direction X1 of the peripheral wall 50. The slit 53 is open in the first direction X1. That is, the slit 53 is formed to be cut in the first opposite direction X2 from the end surface in the first direction X1 of the peripheral wall 50.

An end part in the first direction X1 of the peripheral wall 50 is formed into a forked structure by the slit 53. That is, the end part in the first direction X1 of the peripheral wall 50 includes two forked divided portions 57. Each divided portion 57 includes the divided tubular portion 52. Each divided portion 57 is, for example, formed to be cantilevered and supported on an end part in the first opposite direction X2 of the peripheral wall 50. The two divided portions 57 have, for example, the same structure. The two divided portions 57 are formed to be plane-symmetrical with respect to a virtual plane including the center of the slit 53 in the Z-axis direction and extending in the X-axis direction.

As shown in FIG. 8, both end parts in the axial direction of the tubular connecting portion 60 include guide-in portions 61, 62 for guiding the columnar connecting portion 201 of the male terminal 200 into the tubular connecting portion 60. The guide-in portion 61 is provided in a first end part in the axial direction of the tubular connecting portion 60, i.e. an end part in the third opposite direction Z2 of the tubular connecting portion 60. The guide-in portion 62 is provided in a second end part in the axial direction of the tubular connecting portion 60, i.e. an end part in the third direction Z1 of the tubular connecting portion 60. Each of the guide-in portions 61, 62 is formed over the entire periphery in the circumferential direction of the tubular connecting portion 60. Each guide-in portion 61, 62 is formed over the entire periphery in the circumferential direction of the tubular portion 41 and formed over the entire periphery in the circumferential direction of the tubular portion 51. That is, both the tubular portions 41, 51 include the guide-in portions 61, 62. Note that, since the guide-in portion 62 has the same shape as the guide-in portion 61, the guide-in portion 62 is not described in detail here.

The guide-in portion 61 is formed to have a larger opening area of the tubular connecting portion 60 toward a first opening end of the tubular connecting portion 60 in the first end part, i.e. an opening end in the third opposite direction Z2 of the tubular connecting portion 60. The guide-in portion 61 is formed to project further outward than the outer peripheral surface of the tubular connecting portion 60 excluding the guide-in portions 61, 62. A thickness of the guide-in portion 61 is equal to that of the tubular connecting portion 60 excluding the guide-in portions 61, 62. In other words, the tubular connecting portion 60 is formed to have a constant thickness in a radial direction of the tubular connecting portion 60 over the entire length of the tubular connecting portion 60 including the guide-in portions 61, 62.

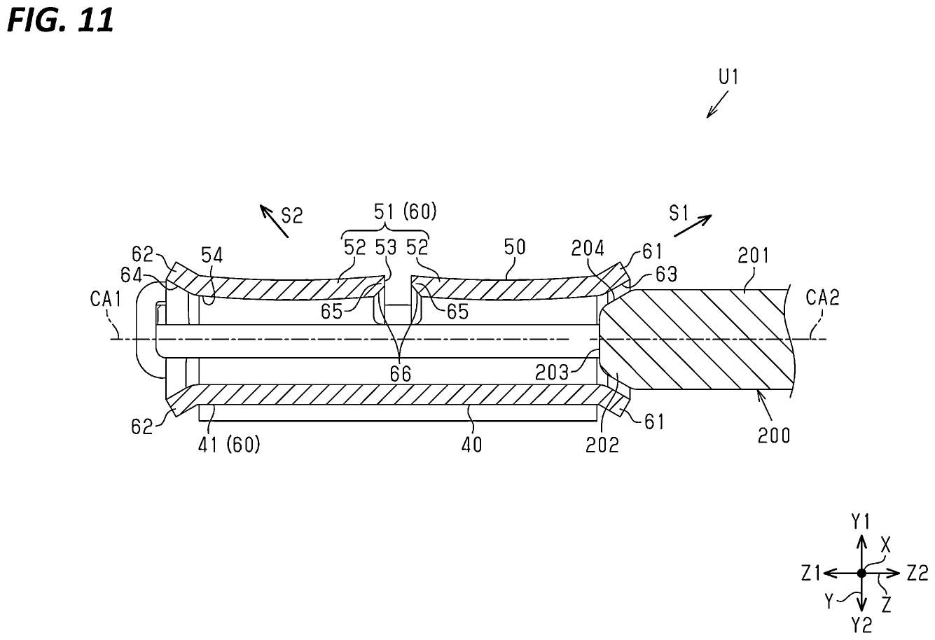

As shown in FIG. 11, the guide-in portion 61 is formed to increase an inner diameter and an outer diameter of the tubular connecting portion 60 toward the first opening end of the tubular connecting portion 60 in the axial direction of the tubular connecting portion 60. The inner peripheral surface of the guide-in portion 61 is formed into an inclined surface 63 inclined radially outwardly of the tubular connecting portion 60 toward the first opening end of the tubular connecting portion 60 in the axial direction of the tubular connecting portion 60. The inclined surface 63 is inclined in a direction separating from the columnar connecting portion 201 toward the first opening end of the tubular connecting portion 60. The inclined surface 63 extends along a first oblique direction S1 inclined at a first angle of inclination to a center axis CA1 of the tubular connecting portion 60. Here, the first angle of inclination is an acute angle formed by an extension direction of the center axis CA1 and the first oblique direction S1 in a YZ plane. The first angle of inclination is, for example, preferably in a range of 20° to 45°, more preferably in a range of 30° to 40°. The outer peripheral surface of the guide-in portion 61 is formed to be inclined radially outwardly of the tubular connecting portion 60 toward the first opening end of the tubular connecting portion 60 in the axial direction of the tubular connecting portion 60. The outer peripheral surface of the guide-in portion 61 extends, for example, in parallel to the inclined surface 63. That is, the outer peripheral surface of the guide-in portion 61 obliquely extends at the same first angle of inclination as the inclined surface 63. In other words, the outer peripheral surface of the guide-in portion 61 extends along the first oblique direction S1.

The guide-in portion 62 is formed to increase an opening area of the tubular connecting portion 60 toward the second opening end of the tubular connecting portion 60 in the second end part, i.e. an opening end in the third direction Z1 of the tubular connecting portion 60. The inner peripheral surface of the guide-in portion 62 is formed into an inclined surface 64 inclined radially outwardly of the tubular connecting portion 60 toward the second opening end of the tubular connecting portion 60 in the axial direction of the tubular connecting portion 60. The inclined surface 64 obliquely extends at the same first angle of inclination as the inclined surface 63 with respect to the center axis CA1 of the tubular connecting portion 60. The guide-in portion 62 is formed to project further outward than the outer peripheral surface of the tubular connecting portion 60 excluding the guide-in portions 61, 62. A thickness of the guide-in portion 62 is equal to that of the tubular connecting portion 60 excluding the guide-in portions 61, 62.

Here, the columnar connecting portion 201 is inserted into the tubular connecting portion 60 along the third direction Z1. The columnar connecting portion 201 includes a tip part 202 formed into a tapered shape. The tip part 202 is provided on an inserting tip of the columnar connecting portion 201, i.e. an end part in the third direction Z1 of the columnar connecting portion 201. The tip part 202 is formed to become thinner toward a tip surface 203 of the columnar connecting portion 201, i.e. an end surface in the third direction Z1 of the columnar connecting portion 201. Here, the tip surface 203 is formed into a flat surface. The outer peripheral surface of the tip part 202 is formed into an inclined surface 204 inclined radially inwardly of the columnar connecting portion 201 toward the tip surface 203. The inclined surface 204 is inclined to approach a center axis CA2 of the columnar connecting portion 201 toward the tip surface 203. The inclined surface 204 extends, for example, in parallel to the inclined surface 63 of the guide-in portion 61. That is, the inclined surface 204 obliquely extends at the same first angle of inclination as the inclined surface 63 with respect to the center axis CA2 of the columnar connecting portion 201. In other words, the inclined surface 204 extends along the first oblique direction S1.

Each guide-in portion 61, 62 has a function of guiding the columnar connecting portion 201 into the tubular connecting portion 60 while aligning the center axis CA2 of the columnar connecting portion 201 and the center axis CA1 of the tubular connecting portion 60 when the columnar connecting portion 201 of the male terminal 200 is inserted into the tubular connecting portion 60. Such guide-in portions 61, 62 are provided in the both end parts in the axial direction of the tubular connecting portion 60.

Each of the two divided tubular portions 52 includes a third end part directly communicating with the slit 53. The third end part of each divided tubular portion 52 is facing the other divided tubular portion 52. The third end part of each divided tubular portion 52 includes a guiding portion 65. The guiding portion 65 is formed to increase an opening area of the tubular connecting portion 60 toward the slit 53. The guiding portion 65 is, for example, formed to make the divided tubular portion 52 thinner toward the slit 53. The guiding portion 65 is formed to increase only the inner diameter, out of the inner and outer diameters of the tubular connecting portion 60, toward the slit 53 in the axial direction of the tubular connecting portion 60. The inner peripheral surface of the guiding portion 65 is formed into an inclined surface 66 inclined radially outwardly of the tubular connecting portion 60 toward the slit 53 in the axial direction of the tubular connecting portion 60. The inclined surface 66 is inclined in a direction separating from the columnar connecting portion 201 toward the slit 53. The inclined surface 66 extends along a second oblique direction S2 inclined at a second angle of inclination to the center axis CA1 of the tubular connecting portion 60. The second angle of inclination is an acute angle formed by the extension direction of the center axis CA1 and the second oblique direction S2 in a YZ plane. The inclined surface 66 is, for example, formed over the entire periphery in the circumferential direction of the inner surface 54 of the divided tubular portion 52.

Here, a dimension of the inclined surface 63 along the first oblique direction S1 is larger than a dimension of the inclined surface 66 along the second oblique direction S2. The first angle of inclination of the inclined surface 63 is smaller than the second angle of inclination of the inclined surface 66.

As shown in FIG. 5, the peripheral wall 40 includes, for example, a pair of cuts 48. The pair of cuts 48 are provided in both end parts in the Z-axis direction of the peripheral wall 40. The pair of cuts 48 are provided to overlap each other in a plan view from the Z-axis direction. The pair of cuts 48 are provided adjacent to the coupling portion 70 and the wound pressing portion 90 in the X-axis direction. Each cut 48 penetrates through the peripheral wall 40 in the Y-axis direction. Each cut 48 is formed to be cut inwardly of the peripheral wall 40 from an end surface in the Z-axis direction of the peripheral wall 40. A dimension of the peripheral wall 40 along the Z-axis direction in a part provided with the pair of cuts 48 is smaller than in other parts.

As shown in FIG. 6, the peripheral wall 50 includes, for example, a pair of cuts 58. The pair of cuts 58 are provided in both end parts in the Z-axis direction of the peripheral wall 50. The pair of cuts 58 are provided to overlap each other in a plan view from the Z-axis direction. The pair of cuts 58 are provided adjacent to the coupling portion 70 and the wound pressing portion 90 in the X-axis direction. As shown in FIG. 10, the respective cuts 58 are provided to overlap the respective cuts 48 in a plan view from the Y-axis direction. Each cut 58 penetrates through the peripheral wall 50 in the Y-axis direction. Each cut 58 is formed to be cut inwardly of the peripheral wall 50 from an end surface in the Z-axis direction of the peripheral wall 50. A dimension of the peripheral wall 50 along the Z-axis direction in a part provided with the pair of cuts 58 is smaller than in other parts.

### (Configuration of Coupling Portion 70)

The coupling portion 70 couples the peripheral walls 40, 50. The coupling portion 70 couples an end part in the third opposite direction Z2 of the peripheral wall 40 and an end part in the third opposite direction Z2 of the peripheral wall 50. The coupling portion 70 is integrally formed to the peripheral wall 40 and integrally formed to the peripheral wall 50. The coupling portion 70 is formed to be folded from an end surface in the third opposite direction Z2 of the peripheral wall 40 toward an end surface in the third opposite direction Z2 of the peripheral wall 50.

The coupling portion 70 is, for example, provided on the end part in the first opposite direction X2 of the peripheral wall 40. The coupling portion 70 extends in the first direction X1 from the end part in the first opposite direction X2 of the peripheral wall 40. The coupling portion 70 projects further in the third opposite direction Z2 than the end surface in the third opposite direction Z2 of the peripheral wall 40 and projects further in the third opposite direction Z2 than the end surface in the third opposite direction Z2 of the peripheral wall 50.

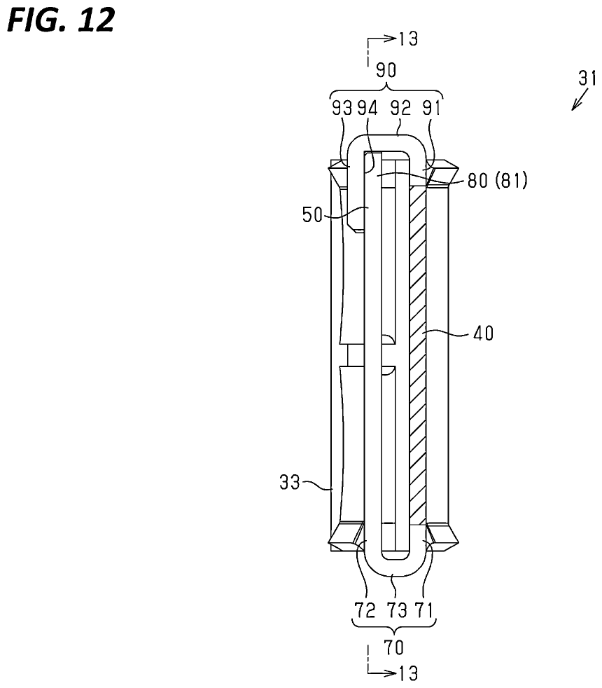

As shown in FIG. 12, the coupling portion 70 includes an extending portion 71 extending in the third opposite direction Z2 from the end surface in the third opposite direction Z2 of the peripheral wall 40 and an extending portion 72 extending in the third opposite direction Z2 from the end surface in the third opposite direction Z2 of the peripheral wall 50. The coupling portion 70 includes a folded portion 73 linking the extending portions 71 and 72.

The extending portion 71 is formed integrally and continuously with the peripheral wall 40. The folded portion 73 is formed integrally and continuously with the extending portion 71. The folded portion 73 is formed to be folded toward the peripheral wall 50 from an end part of the extending portion 71. The folded portion 73 is, for example, folded in the third direction Z1 into a U shape from the end part of the extending portion 71. The second extending portion 72 extends in the third direction Z1 toward the peripheral wall 50 from the folded portion 73. The extending portion 72 is formed integrally and continuously with the folded portion 73 and formed integrally and continuously with the peripheral wall 50. The coupling portion 70 is folded into a U shape convex in a direction separating from the peripheral walls 40, 50 (here, third opposite direction Z2) by the extending portion 71, the folded portion 73 and the extending portion 72. The coupling portion 70 is so folded that the peripheral wall 50 is arranged to face the peripheral wall 40. In other words, the peripheral wall 50 is folded into two toward the peripheral wall 40 by the coupling portion 70 in the terminal connecting portion 33.

The coupling portion 70 is, for example, formed by bending one metal plate material. Here, since the cuts 48, 58 are provided at positions adjacent to the coupling portion 70, the metal plate material is easily bent in forming the coupling portion 70.

### (Configuration of Projecting Portion 80)

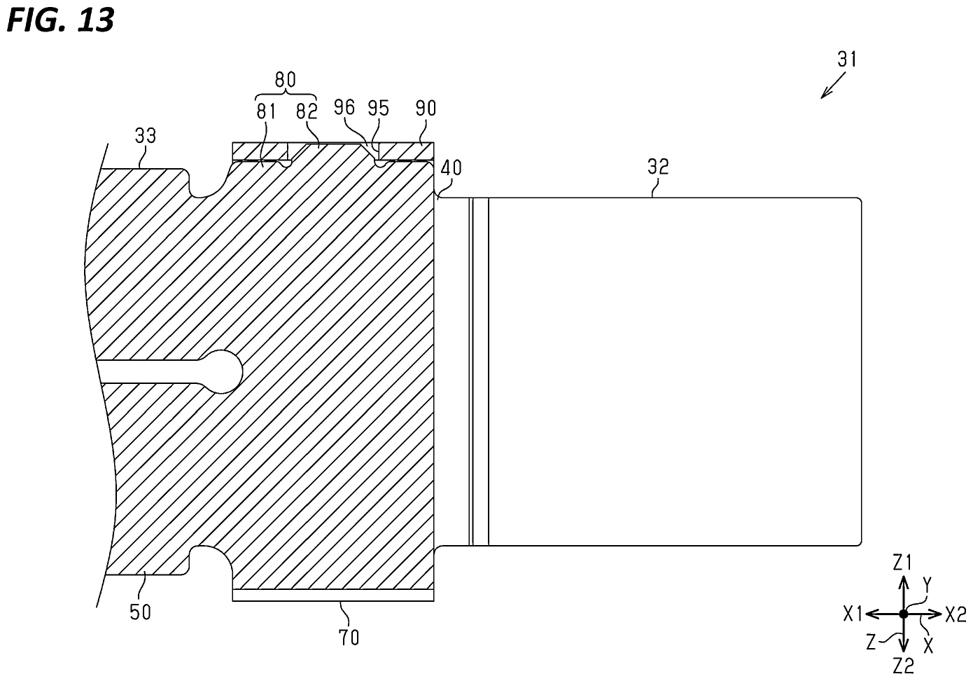

As shown in FIG. 13, the projecting portion 80 is provided on an end surface in the third direction Z1 of the peripheral wall 50. The projecting portion 80 includes, for example, a projecting base portion 81 extending in the third direction Z1 from the end surface in the third direction Z1 of the peripheral wall 50 and a projection 82 extending in the third direction Z1 from a part of the projecting tip surface of the projecting base portion 81. The projecting base portion 81 is formed integrally and continuously with the peripheral wall 50. The projecting base portion 81 extends along the first direction X1 from an end surface in the first opposite direction X2 of the peripheral wall 50. The projection 82 is formed integrally and continuously with the projecting base portion 81. The projection 82 projects further in the third direction Z1 than the projecting tip surface, here an end surface in the third direction Z1, of the projecting base portion 81. The projection 82 is, for example, provided only at an intermediate position in the X-axis direction of the projecting base portion 81. The projection 82 is, for example, formed to reduce a width along the X-axis direction toward the projecting tip surface of the projection 82 from the projecting base portion 81 in a plan view from the Y-axis direction.

### (Configuration of Wound Pressing Portion 90)

As shown in FIG. 4, the wound pressing portion 90 is formed to limit a separation distance between the inner surface 42 of the tubular portion 41 and the inner surface 54 of the tubular portion 51. The wound pressing portion 90 limits an increase of the separation distance between the inner surfaces 42 and 54. The wound pressing portion 90 limits the opening of the coupling portion 70. The wound pressing portion 90 is integrally formed to the peripheral wall 40. The wound pressing portion 90 is, for example, provided on an end part in the third direction Z1 of the peripheral wall 40. The wound pressing portion 90 is formed to extend from the peripheral wall 40 and be folded while embracing an end edge of the peripheral wall 50 inside. The wound pressing portion 90 is formed to be folded from the end surface in the third direction Z1 of the peripheral wall 40 with the end surface in the third direction Z1 of the peripheral wall 50 arranged inside. The wound pressing portion 90 is in contact with the outer surface of the peripheral wall 50.

The wound pressing portion 90 is, for example, provided on the end part in the first opposite direction X of the peripheral wall 40. The wound pressing portion 90 extends in the first direction X1 from the end part in the first opposite direction X2 of the peripheral wall 40. The wound pressing portion 90 is, for example, provided at a position overlapping the coupling portion 70 in a plan view from the Z-axis direction. The wound pressing portion 90 is, for example, provided on a side opposite to the coupling portion 70 across the peripheral wall 40 in the Z-axis direction.

As shown in FIG. 12, the wound pressing portion 90 includes an extending portion 91 extending in the third direction Z1 from the end surface in the third direction Z1 of the peripheral wall 40, a folded portion 92 provided on an end part of the extending portion 91 and a pressing portion 93 extending from an end part of the folded portion 92 toward the peripheral wall 50.

The extending portion 91 is formed continuously and integrally with the peripheral wall 40. The folded portion 92 is formed continuously and integrally with the extending portion 91. The folded portion 92 is formed to be folded from an end part in the third direction Z1 of the extending portion 91 toward the peripheral wall 50. The folded portion 92 is, for example, folded in the third opposite direction Z2 into a U shape from the end part of the extending portion 91. The pressing portion 93 is formed continuously and integrally with the folded portion 92. The pressing portion 93 extends in the third opposite direction Z2 from the folded portion 92 toward the projecting portion 80 and the peripheral wall 50. The wound pressing portion 90 is folded into a U shape convex in a direction separating from the peripheral walls 40 and 50 (here, third direction Z1) by the extending portion 91, the folded portion 92 and the pressing portion 93.

The pressing portion 93 is provided to press the outer surface of the peripheral wall 50 from outside. The pressing portion 93 is, for example, provided to press the outer surface of the projecting base portion 81 from outside. The pressing portion 93 has a facing surface 94 facing the outer surface of the peripheral wall 50. The facing surface 94 extends, for example, in parallel to the outer surface of the peripheral wall 50. The facing surface 94 is, for example, in surface contact with the outer surface of the peripheral wall 50.

As shown in FIG. 4, the wound pressing portion 90 includes a through hole 95, into which the projection 82 is fit. The through hole 95 penetrates through the wound pressing portion 90 in a thickness direction. The through hole 95 extends, for example, from an intermediate position of the folded portion 92 to an intermediate position of the pressing portion 93. The through hole 95 is formed into such a size that the projection 82 is fittable thereinto.

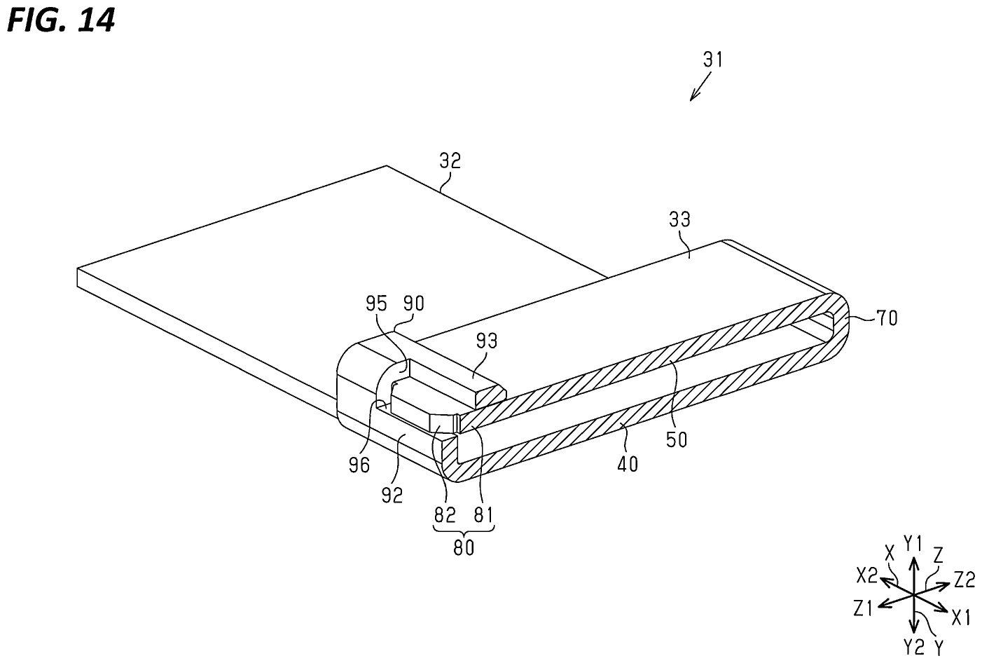

As shown in FIG. 14, the wound pressing portion 90 has an engaging surface 96 forming the through hole 95 and to be engaged with the projection 82. The engaging surface 96 is, for example, facing in the second direction Y1. The engaging surface 96 is facing the inner surface of the projection 82 in the Y-axis direction. The engaging surface 96 extends, for example, in parallel to the inner surface of the projection 82. The engaging surface 96 is, for example, in surface contact with the inner surface of the projection 82. The outer surface of the projection 82 is, for example, exposed from the wound pressing portion 90 through the through hole 95.

In the terminal connecting portion 33 of this embodiment, the outer surface of the peripheral wall 50 is pressed from outside by the pressing portion 93 of the wound pressing portion 90 and the engaging surface 96 of the wound pressing portion 90 is pressed from outside by the projection 82 of the projecting portion 80. In this way, an increase in the separation distance of the peripheral walls 40, 50 can be stably limited.

The wound pressing portion 90 is, for example, formed by bending one metal plate material. Here, since the cuts 48, 58 are provided at positions adjacent to the wound pressing portion 90 as shown in FIGS. 5 and 6, the metal plate material is easily bent in forming the wound pressing portion 90.

### (Configuration of Protecting Portion 100)

As shown in FIG. 4, the protecting portion 100 is, for example, provided to protect an end part in the first direction X1 of the terminal connecting portion 33. The protecting portion 100 is provided on the end part in the first direction X1 of the peripheral wall 40. The protecting portion 100 is, for example, integrally formed to the peripheral wall 40. The protecting portion 100 is formed to be folded from the end part in the first direction X1 of the peripheral wall 40 while arranging the end part in the first direction X2 of the peripheral wall 50 inside.

The protecting portion 100 includes an extending portion 101 extending in the second direction Y1 from the end part in the first direction X1 of the peripheral wall 40 and a protection wall 102 extending from an end part in the second direction Y1 of the extending portion 101 toward the peripheral wall 50. The extending portion 101 is formed continuously and integrally with the peripheral wall 40. The protection wall 102 is formed continuously and integrally with the extending portion 101. The protecting portion 100 is folded into a U shape convex in a direction separating from the peripheral wall 50 (here, first direction X1) by the extending portion 101 and the protection wall 102. The protection wall 102 is provided to face the end part in the first direction X1 of the peripheral wall 50 in the Y-axis direction. The protection wall 102 is provided apart from the outer surface of the peripheral wall 50. That is, a gap is provided between the protection wall 102 and the outer surface of the peripheral wall 50. The protection wall 102 is provided apart from the outer surface of the peripheral wall 50, for example, with the columnar connecting portion 201 inserted in the tubular connecting portion 60.

### (Configuration of Housing Body 110)

As shown in FIG. 3, the housing body 110 holds the female terminals 31 in such a manner that the wires 20 are drawn out in the first opposite direction X2. The housing body 110 accommodates two female terminals 31 inside. The housing body 110 is, for example, formed into a box shape as a whole. The housing body 110 is, for example, made of synthetic resin.

The housing body 110 includes an opening 111 open in the first opposite direction X2. The wire 20 connected to the female terminal 31 is pulled out to the outside of the housing body 110 through the opening 111. The housing body 110 includes, for example, a peripheral wall 112 provided in the third opposite direction Z2 and a tube portion 113 provided on the outer surface of the peripheral wall 112. The tube portion 113 is a fitting tube portion, into which the mating housing of the unillustrated mating connector is fit. The tube portion 113 is provided on an end part in the first direction X1 of the peripheral wall 112. The tube portion 113 projects radially outward (here, third opposite direction Z2) of the housing body 110 from the outer surface of the peripheral wall 112. The tube portion 113 is, for example, formed into a rectangular tube shape.

The tube portion 113 includes an insertion hole 114. The insertion hole 114 is formed to allow communication between the inside and outside of the housing body 110. The insertion hole 114 is open in the third direction Z1 and also in the third opposite direction Z2. The insertion hole 114 penetrates, for example, through the tube portion 113 in the Z-axis direction and the peripheral wall 112 in the Z-axis direction. The insertion hole 114 is formed to expose the female terminals 31 accommodated in the housing body 110. Here, each female terminal 31 accommodated inside the housing body 110 is so provided that the opening end of the tubular connecting portion 60 is exposed through the insertion hole 114.

### (Configuration of Retainer 120)

The retainer 120 is mounted into the tube portion 113 of the housing body 110. The retainer 120 includes a body portion 121 and one or more (two in this embodiment) restricting portions 122 for restricting movements of the female terminals 31 in the first opposite direction X2. The retainer 120 is, for example, a single component in which the body portion 121 and the restricting portions 122 are formed continuously and integrally. The retainer 120 is, for example, made of synthetic resin.

The body portion 121 is, for example, formed into a frame shape as a whole. The outer peripheral edge of the body portion 121 is, for example, formed to have a rectangular shape in a plan view from the Z-axis direction. The body portion 121 is, for example, formed to cover an end surface in the third opposite direction Z2 of the tube portion 113.

The body portion 121 includes one or more (two in this embodiment) insertion holes 123. Each insertion hole 123 penetrates through the body portion 121 in the Z-axis direction. Each insertion hole 123 is formed to communicate with the insertion hole 114 of the tube portion 113. The two insertion holes 123 are, for example, formed to respectively expose the opening ends of the tubular connecting portions 60 of the two female terminals 31 accommodated in the housing body 110.

As shown in FIG. 2, the two restricting portions 122 are provided to respectively correspond to the two female terminals 31. The two restricting portions 122 are, for example, provided side by side along the Y-axis direction. Each restricting portion 122 is, for example, formed into a tube for accommodating a part of the female terminal 31. When the retainer 120 is mounted into the housing body 110 along the third direction Z1, the female terminals 31 are inserted into internal spaces of the restricting portions 122. If the retainer 120 is mounted into the housing body 110, movements of the female terminals 31 in the first opposite direction X2 are restricted by the restricting portions 122.

Next, functions and effects of this embodiment are described.

(1) The female terminal 31 includes the peripheral wall 40 extending along the first direction X1 and the peripheral wall 50 extending along the first direction X1 and facing the peripheral wall 40 in the second direction Y1 orthogonal to the first direction X1. The female terminal 31 includes the tubular portion 41 provided in the peripheral wall 40, the tubular portion 51 provided in the peripheral wall 50 to face the tubular portion 41 and the tubular connecting portion 60 constituted by the tubular portions 41, 51. The axial direction of the tubular connecting portion 60 extends along the third direction Z1 intersecting both the first direction X1 and the second direction Y1. The tubular connecting portion 60 is a part, into which the columnar connecting portion 201 of the male terminal 200 is inserted along the third direction Z1 and to which the columnar connecting portion 201 is electrically connected. Both the tubular portions 41, 51 include the guide-in portion 61 provided in the first end part in the axial direction of the tubular connecting portion 60, here the end part in the third opposite direction Z2 of the tubular connecting portion 60, and configured to guide the columnar connecting portion 201 into the tubular connecting portion 60. The inner peripheral surface of the guide-in portion 61 is formed into the inclined surface 63 inclined radially outwardly of the tubular connecting portion 60 toward the first opening end of the tubular connecting portion 60 in the first end part, here the opening end in the third opposite direction Z2 of the tubular connecting portion 60.

According to this configuration, the inner peripheral surface of the guide-in portion 61 provided in the first end part in the axial direction of the tubular connecting portion 60 is formed into the inclined surface 63 inclined radially outwardly toward the first opening end in the first end part. Thus, when the columnar connecting portion 201 of the male terminal 200 is inserted into the tubular connecting portion 60, the tip part 202 of the columnar connecting portion 201 is guided into the tubular connecting portion 60 along the inclined surface 63 of the guide-in portion 61. In this way, even if the center axis CA2 of the columnar connecting portion 201 deviates from the center axis CA1 of the tubular connecting portion 60, the center axis CA2 can be aligned with the center axis CA1 by moving the tip part 202 of the columnar connecting portion 201 along the inclined surface 63. As a result, by providing the guide-in portion 61, the center axis CA1 of the tubular connecting portion 60 and the center axis CA2 of the columnar connecting portion 201 can be easily aligned in inserting the columnar connecting portion 201 into the tubular connecting portion 60.

(2) The guide-in portion 61 is formed to have the same thickness as the other part of the tubular connecting portion 60. Thus, a conductor cross-sectional area of the tubular connecting portion 60 can be increased as compared to the case where the inclined surface 63 is formed by making the guide-in portion 61 thinner toward the first opening end of the tubular connecting portion 60. In this way, a heat capacity of the female terminal 31 can be increased and a conductor resistance of the female terminal 31 can be reduced. As a result, a temperature increase of the female terminal 31 during energization can be suitably suppressed.

(3) The guide-in portions 61, 62 are respectively provided in both end parts in the axial direction of the tubular connecting portion 60, i.e. in the first and second end parts. Thus, regardless of in which of the both end parts of the tubular connecting portion 60 an insertion opening for the columnar connecting portion 201 into the tubular connecting portion 60 is set, the columnar connecting portion 201 can be inserted into the tubular connecting portion 60 while the center axes CA1, CA2 are aligned. Therefore, limitations in an insertion direction of the columnar connecting portion 201 with respect to the axial direction of the tubular connecting portion 60 can be eliminated.

(4) The tubular portion 51 includes the plurality of divided tubular portions 52 divided in the axial direction of the tubular connecting portion 60. Each of the plurality of divided tubular portions 52 has the inner surface 54 facing the tubular portion 41 and the protruding portion 56 arcuately projecting radially inwardly of the tubular connecting portion 60 from the inner surface 54 in cross-section.

According to this configuration, when the columnar connecting portion 201 of the male terminal 200 is press-fit into the tubular connecting portion 60, the protruding portions 56 provided on the respective inner surfaces 54 of the plurality of divided tubular portions 52 are pressed into contact with the outer peripheral surface of the columnar connecting portion 201. Thus, in the tubular connecting portion 60, the plurality of protruding portions 56 are pressed into contact with the outer peripheral surface of the columnar connecting portion 201 at a plurality of positions separated in the axial direction. In this way, for example, even if a swinging motion is transferred to the male terminal 200, a displacement of the male terminal 200 due to that swinging motion can be suitably hindered by the contact of the plurality of protruding portions 56 with the columnar connecting portion 201. That is, a displacement of the columnar connecting portion 201 inside the tubular connecting portion 60 can be suppressed by a contact pressure by the plurality of protruding portions 56 as compared to the case where only one protruding portion 56 is provided on the inner surface 54 of the tubular portion 51.

(5) The slit 53 dividing the two divided tubular portions 52 is provided at the center position of the tubular connecting portion 60 in the axial direction. Here, if a swinging motion of an unillustrated mating wire or the like is transferred to the columnar connecting portion 201 inserted in the tubular connecting portion 60 as shown in FIG. 9, the columnar connecting portion 201 may be displaced in a direction of an arrow in FIG. 9 inside the tubular connecting portion 60 due to that swinging motion. Specifically, the columnar connecting portion 201 may rotate in the direction of the arrow in FIG. 9 about the center A1 in the axial direction of the tubular connecting portion 60 as a rotation center due to the above swinging motion. At this time, for example, if the projecting tip 56A of the protruding portion 56 provided on the tubular portion 51 is provided at the center A1 of the tubular connecting portion 60, a contact part of the projecting tip 56A of the protruding portion 56 and the columnar connecting portion 201 becomes a rotation center in the displacement of the columnar connecting portion 201. In this case, a contact pressure with the columnar connecting portion 201 by the protruding portion 56 cannot be applied as a force for suppressing the displacement of the columnar connecting portion 201. In contrast, in the female terminal 31 of this embodiment, the protruding portions 56 are provided at the positions different from the slit 53 provided at the center A1. Thus, the protruding portions 56 and the columnar connecting portion 201 can be brought into contact at positions different from the rotation center in the displacement of the columnar connecting portion 201. In this way, a contact pressure with the columnar connecting portion 201 by the protruding portions 56 can be suitably applied as a force for suppressing the displacement of the columnar connecting portion 201. As a result, the displacement of the columnar connecting portion 201 inside the tubular connecting portion 60 can be suitably suppressed by the contact pressure by the plurality of protruding portions 56. More particularly, each protruding portion 56 can suppress the displacement of the columnar connecting portion 201 by a force of F1×μ×L1 if F1 denotes the contact pressure with the columnar connecting portion 201 by each protruding portion 56 and μ denotes a friction coefficient. Therefore, the two protruding portions 56 can suppress the displacement of the columnar connecting portion 201 by a force of 2×F1×μ×L1.

(6) The inner peripheral surface of the guiding portion 65 provided in the third end part of the divided tubular portion 52 is formed into the inclined surface 66 inclined radially outwardly toward the slit 53. Thus, when the tip part 202 of the columnar connecting portion 201 is inserted into the divided tubular portion 52 through the slit 53, the tip part 202 of the columnar connecting portion 201 is guided into the divided tubular portion 52 along the inclined surface 66 of the guiding portion 65. In this way, the columnar connecting portion 201 can be smoothly guided into the divided tubular portion 52.

(7) The inclined surface 63 extends along the first oblique direction S1 inclined at the first angle of inclination with respect to the center axis CA1 of the tubular connecting portion 60. The inclined surface 66 extends along the second oblique direction S2 inclined at the second angle of inclination with respect to the center axis CA1. The dimension of the inclined surface 63 along the first oblique direction S1 is larger than that of the inclined surface 66 along the second oblique direction S2. According to this configuration, the inclined surface 63 can be formed to be long along the first oblique direction S1. In this way, a distance from the first opening end of the tubular connecting portion 60, i.e. the opening end in the third opposite direction Z2 of the tubular connecting portion 60, to a contact point part of the tubular connecting portion 60, i.e. a part of the tubular connecting portion 60 excluding the guide-in portions 61, 62, can be made long. Thus, when the columnar connecting portion 201 is inserted into the tubular connecting portion 60, a moving distance of the columnar connecting portion 201 can be made longer while the center axis CA1 of the tubular connecting portion 60 and the center axis CA2 of the columnar connecting portion 201 are aligned. Therefore, the alignment accuracy of the center axis CA1 of the tubular connecting portion 60 and the center axis CA2 of the columnar connecting portion 201 can be improved.

(8) The inclined surface 63 is formed into an inclined surface inclined more gently than the inclined surface 66. Thus, when the columnar connecting portion 201 is inserted into the tubular connecting portion 60, a pressure generated between the tip part 202 of the columnar connecting portion 201 and the inclined surface 63 can be reduced. In this way, the amount of wear of the tubular connecting portion 60 during the insertion of the columnar connecting portion 201 can be reduced.

(9) When the columnar connecting portion 201 of the male terminal 200 is press-fit into the tubular connecting portion 60, an increase in the separation distance between the inner surface 42 constituting the tubular connecting portion 60 and the inner surface 54 constituting the tubular connecting portion 60 is limited by the wound pressing portion 90. By this limitation by the wound pressing portion 90, the protruding portions 56 and the linear contact portions 43 can be suitably brought into contact with the outer peripheral surface of the columnar connecting portion 201. As a result, a press-contact state of the tubular connecting portion 60 and the columnar connecting portion 201 can be stably maintained. Further, the wound pressing portion 90 is integrally formed to the peripheral wall 40. Thus, the press-contact state of the tubular connecting portion 60 and the columnar connecting portion 201 can be maintained by a simple structure as compared to the case of using a separate component such as a coil spring. That is, the structure of the female terminal 31 can be simplified as compared to the case of using a separate component such as a coil spring.

(10) The columnar connecting portion 201 includes the tip part 202 formed into a tapered shape. The outer peripheral surface of the tip part 202 extends in parallel to the inclined surface 63. That is, the outer peripheral surface of the tip part 202 is formed into the inclined surface 204 extending along the first oblique direction S1. According to this configuration, when the columnar connecting portion 201 is inserted into the tubular connecting portion 60, the inclined surface 204 of the tip part 202 of the columnar connecting portion 201 and the inclined surface 63 extending in parallel to the inclined surface 201 are brought into contact with each other. Thus, a contact area of the inclined surfaces 63, 204 during the insertion of the columnar connecting portion 201 can be increased as compared to the case where a slope and a perpendicular surface are brought into contact with each other. In this way, a surface pressure applied to the inclined surface 63 from the tip part 202 of the columnar connecting portion 201 can be suitably reduced. Therefore, the amount of wear of the columnar connecting portion 201 and the tubular connecting portion 60 during the insertion of the columnar connecting portion 201 can be suitably reduced.

### OTHER EMBODIMENTS

The above embodiment can be modified and carried out as follows. The above embodiment and the following modifications can be combined with each other without technically contradicting.
The structure of the female terminal 31 in the above embodiment can be changed as appropriate.
The second angle of inclination of the inclined surface 66 may be changed to be equal to the first angle of inclination of the inclined surface 63.
The dimension of the inclined surface 63 along the first oblique direction S1 may be changed to be equal to the dimension of the inclined surface 66 along the second oblique direction S2.
The guide-in portion 61, 62 may be formed to become thinner toward the opening end in the axial direction of the tubular connecting portion 60.
The guiding portion 65 in the divided tubular portion 52 of the female terminal 31 may be omitted.
In the female terminal 31 of the above embodiment, the plurality of linear contact portions 43 are provided on the inner surface 42 of the tubular portion 41 and the tubular portion 51 includes the plurality of divided tubular portions 52 and the protruding portions 56 provided on the inner surfaces 54 of the divided tubular portions 52, but there is no limitation to this. For example, the tubular portion 51 may include the plurality of linear contact portions 43.
In the female terminal 31 of the above embodiment, each protruding portion 56 may be provided only at the intermediate position in the axial direction of the divided tubular portion 52.
The number of the divided tubular portions 52 of the tubular portion 51 of the above embodiment is not particularly limited. For example, the tubular portion 51 may include three or more divided tubular portions 52.
The structure of the slit 53 of the above embodiment can be changed as appropriate.
The slit 53 may be omitted. The tubular portion 51 in this case is, for example, not divided in the axial direction of the tubular connecting portion 60 and includes one protruding portion 56 on the inner surface 54.
The protecting portion 100 in the above embodiment may be integrally formed to the peripheral wall 50. The protecting portion 100 in this case is, for example, formed to be folded from the end part in the first direction X1 of the peripheral wall 50 toward the end part in the first direction X1 of the peripheral wall 40.
The protecting portion 100 of the female terminal 31 may be omitted.
The position of the wound pressing portion 90 in the female terminal 31 may be changed as appropriate. For example, the wound pressing portion 90 may be located at a position different from the coupling portion 70 in the X-axis direction.
In the above embodiment, the contact pressure with the columnar connecting portion 201 is ensured by limiting the separation distance between the inner surfaces 42 and 52 by the wound pressing portion 90, but there is no limitation to this. For example, the contact pressure with the columnar connecting portion 201 may be ensured, using a biasing member such a coil spring separate from the peripheral walls 40, 50.
In the above embodiment, the wire connecting portion 32 is integrally formed to the peripheral wall 40, but there is no limitation to this. For example, the wire connecting portion 32 may be integrally formed to the peripheral wall 50.
In the female terminal 31 of the above embodiment, only the terminal connecting portion 33, out of the wire connecting portion 32 and the terminal connecting portion 33, is folded into two to place the peripheral wall 50 over the peripheral wall 40, but there is no limitation to this. For example, both the wire connecting portion 32 and the terminal connecting portion 33 may be structured by folding two plate materials.
As long as the housing body 110 in the above embodiment is structured to be able to accommodate the female terminals 31, the other structure of the housing body 110 can be changed as appropriate.
The structure of the retainer 120 in the above embodiment can be changed as appropriate. For example, the restricting portions 122 may be omitted.
The shape of the tip part 202 in the columnar connecting portion 201 of the above embodiment can be changed as appropriate. For example, the inclined surface 204 of the tip part 202 may be formed to be inclined at an angle different from that of the inclined surface 63.
In the above embodiment, the columnar connecting portion 201 of the male terminal 200 is formed into a cylindrical shape, but there is no limitation to this. For example, the columnar connecting portion 201 may be formed into a columnar shape other than the cylindrical shape. For example, the columnar connecting portion 201 may be formed to have an elliptical or polygonal cross-sectional shape.
The embodiment disclosed this time should be considered illustrative in all aspects, rather than restrictive. The scope of the present invention is represented not by the above meaning, but by claims and is intended to include all changes in the scope of claims and in the meaning and scope of equivalents.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A female terminal, comprising:
a first peripheral wall extending along a first direction;
a second peripheral wall extending along the first direction, the second peripheral wall facing the first peripheral wall in a second direction orthogonal to the first direction;
a first tubular portion provided in the first peripheral wall;
a second tubular portion provided in the second peripheral wall to face the first tubular portion; and
a tubular connecting portion constituted by the first and second tubular portions,
an axial direction of the tubular connecting portion extending along a third direction intersecting both the first and second directions,
a columnar connecting portion of a male terminal being inserted into the tubular connecting portion along the third direction, the columnar connecting portion being electrically connected to the tubular connecting portion,
both the first and second tubular portions including a first guide-in portion provided in a first end part in the axial direction for guiding the columnar connecting portion into the tubular connecting portion, and
an inner peripheral surface of the first guide-in portion being formed into a first inclined surface inclined radially outwardly of the tubular connecting portion toward a first opening end of the tubular connecting portion in the first end part.

2. The female terminal of claim 1, wherein:
the first guide-in portion is formed to project further outward than an outer peripheral surface of the tubular connecting portion excluding the first guide-in portion, and
a thickness of the first guide-in portion is equal to that of the tubular connecting portion excluding the first guide-in portion.

3. The female terminal of claim 1, wherein:
both the first and second tubular portions include a second guide-in portion provided in a second end part in the axial direction for guiding the columnar connecting portion into the tubular connecting portion, and
an inner peripheral surface of the second guide-in portion is formed into a second inclined surface inclined radially outwardly of the tubular connecting portion toward a second opening end of the tubular connecting portion in the second end part.

4. The female terminal of claim 1, wherein:
the first tubular portion includes a plurality of divided tubular portions divided in the axial direction, and
each of the plurality of divided tubular portions has a first inner surface facing the second tubular portion and a protruding portion arcuately projecting radially inwardly of the tubular connecting portion from the first inner surface in cross-section.

5. The female terminal of claim 4, wherein:
the plurality of divided tubular portions are two divided tubular portions,
the first tubular portion includes a slit dividing the two divided tubular portions, and
the slit is provided at a center position of the tubular connecting portion in the axial direction.

6. The female terminal of claim 5, wherein:
each of the two divided tubular portions includes a guiding portion provided in a third end part directly communicating with the slit,
an inner peripheral surface of the guiding portion is formed into a third inclined surface inclined radially outwardly of the tubular connecting portion toward the slit, and
the guiding portion is formed to make the divided tubular portion thinner toward the slit.

7. The female terminal of claim 6, wherein:
the first inclined surface extends along a first oblique direction inclined at a first angle of inclination with respect to a center axis of the tubular connecting portion,
the third inclined surface extends along a second oblique direction inclined at a second angle of inclination with respect to the center axis, and
a dimension of the first inclined surface along the first oblique direction is larger than a dimension of the third inclined surface along the second oblique direction.

8. The female terminal of claim 7, wherein the first angle of inclination is smaller than the second angle of inclination.

9. The female terminal of claim 4, wherein:
the second tubular portion has a second inner surface facing the first inner surface,
the female terminal further includes a wound pressing portion for limiting a separation distance between the first and second inner surfaces,
the wound pressing portion is integrally formed to the second peripheral wall, and
the wound pressing portion extends from the second peripheral wall, is folded while embracing an end edge of the first peripheral wall inside, and is in contact with an outer surface of the first peripheral wall.

10. A terminal unit, comprising:
the female terminal of claim 1; and
the male terminal including the columnar connecting portion to be inserted into the tubular connecting portion.

11. The terminal unit of claim 10, wherein:
the columnar connecting portion includes a tip part formed into a tapered shape, and
an outer peripheral surface of the tip part extends in parallel to the first inclined surface.
